(19) United States
(12) Patent Application Publication
(10) Pub. No.: US 2013/0317879 A1
(43) Pub. Date: Nov. 28, 2013

(54) WORK PROBLEM ANALYSIS SUPPORT SYSTEM

(71) Applicant: HITACHI, LTD., Tokyo (JP)

(72) Inventors: Hiromi UKAI, Machida (JP); Ryota MIBE, Sagamihara (JP); Hirofumi DANNO, Yokohama (JP); Hideaki ITO, Yokohama (JP); Takafumi KAWASAKI, Machida (JP); Shigetoshi HAYASHI, Fujisawa (JP); Hirofumi SHINKE, Yokohama (JP); Chiaki HIRAI, Tokyo (JP)

(73) Assignee: HITACHI, LTD., Tokyo (JP)

(21) Appl. No.: 13/780,742

(22) Filed: Feb. 28, 2013

(30) Foreign Application Priority Data
May 24, 2012 (JP) 2012-118133

(51) Int. Cl. G06Q 10/06

(52) U.S. Cl. CPC G06Q 10/0633
USPC 705/7.27

(57) ABSTRACT

There is provided a system which analyzes data representative of operation situation of a work system and finds tacit problem hidden in work performed at the a field by a system user. Particularly, the system is to support to find the problem even if the user is not a specialist such as ethnographer. The system includes event examples in which the problems in the work at the field found from user analysis such as observation or interview are classified and expressed as events in operation data when a computer is utilized, analysis menu, analysis function and visualization unit for finding the events.

### INCORPORATION BY REFERENCE

The present application claims priority from Japanese application JP2012-118133 filed on May 24, 2012, the content of which is hereby incorporated by reference into this application.

### BACKGROUND OF THE INVENTION

The present invention relates to the technique of supporting analysis of problem in work and more particularly to an analysis support system for analyzing work on the basis of operation information of a computer system to detect a problem in the work hidden in the field where the work is performed and a support method. Particularly, the present invention relates to analysis of error information.

The first object of systematization is improvement of efficiency in work at the time that a computer system is expensive and the computer systems are introduced into work having higher effect in order. In the present time that the computer systems are spread, most of work is systematized, although plural computer systems having different introduction time are required to be combined depending on work. The case where data inputted once is copied into a memory and then inputted to another computer system again and the case where paper is used even if a new computer system is introduced in order to attain a paperless system can be found. In the field where the work is performed, such operation is performed as usual and accordingly the operator cannot often notice it as a problem, although it can be found by means of a user analysis method such as ethnography.

Further, as another method of grasping the actual conditions of work in the field, many trials utilizing operation information of a computer to visualize the work are reported.

JP-A-2008-225814, the counterpart US publication of which is US 2008-0229296, discloses the technique utilizing update information of data of a computer system to analyze change in work flow (flow of work using the computer system) caused by the elapse of time so that contents of change can be grasped easily.

### SUMMARY OF THE INVENTION

In recent years, information of work is permeated, so that a proposal of a system which supports creative activity of person performed in work rather than efficiency of work to thereby create a new added value is demanded. Accordingly, first, it is necessary to investigate “prevention factor of creative activity and activation factor” hidden in work in the field.

However, the technique described in JP-A-2008-225814 can grasp the change in the work flow from the operation situation of the computer system but has a problem that it is difficult to find a problem hidden in the field.

It is an object of the present invention to provide the technique that data representing the operation situation of a computer system can be analyzed to find a problem hidden in work performed in the field by a system user.

In order to solve the above problem, according to the present invention, attributes of plural pieces of information are specified in analysis of information concerning target work and factor candidates causing problem are specified in consideration of relevance and combination thereof.

For example, there is provided a system including event examples in which the problems in the work at the field found from observation or interview are classified and expressed as events in operation data when a computer is utilized, analysis menu, analysis function, visualization means and data collection means for finding the events. Concretely, the system includes the function of extracting information representing “person”, “work” and “time” as analysis targets and collecting experience year and work place of the “person” corresponding to or contained in each information, pictures utilized in the “work” and job necessary time and “time” characteristic such as specific data and day of week to be analyzed. For example, when error is analyzed, the number of errors and error kind for each month and each day are totalized in conventional error analysis, although the present invention provides means for finding work at the time that error occurs, work performed in parallel to occurrence of error or at the same time, relation between busyness and occurrence of error to make totalization in combination with the above attribute.

According to the present invention, since candidates of problems in work at the field can be found from operation data of a computer system, whether the problems are proper or not can be confirmed by a company utilizing the system and when a specialist such as ethnographer investigates the field, proper field and time can be selected, so that effective field investigation can be made and further creative activity of person can be supported to thereby effect system proposal for creating new added value.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating a system according to an embodiment of the present invention;

FIG. 2 shows the structure of a work actual-condition information management table and a user management table;

FIG. 3 shows the structure of an experience year management table, a base management table and a work level management table;

FIG. 4 is a flow chart showing the processing performed by a work information production program;

FIG. 5 shows the structure of a job necessary time information table;

FIG. 6 shows the preparation procedure and the structure of a simultaneous display picture information table;

FIG. 7 is a flow chart showing the processing performed by a picture display information production program;

FIG. 8 shows the structure of a work error information management table;

FIG. 9 is a flow chart showing the processing performed by a work error information production program;

FIG. 10 shows event examples of problems in work;

FIG. 11 shows analysis menu and analysis examples;

FIG. 12 shows examples of analysis functions;

FIG. 13 is a flow chart showing the processing performed by a work information analysis program;

FIG. 14 is a flow chart showing the processing performed by an analysis result visualization program;

FIG. 15 shows picture examples of analysis;

FIG. 16 shows the structure of a work error element management table and a work error analysis information table; and

FIG. 17 is a flow chart showing the processing performed by an error analysis program.

### DESCRIPTION OF THE EMBODIMENTS

An embodiment of the present invention is now described with reference to the accompanying drawings by taking the case where information relative to “person”, “work” and “time” is collected from system operation data of a computer to analyze a factor causing an error and problem candidates in work are found as an example. The error can be supposed to contain three kinds of errors including (a) an error in work judged as a result of examination of work contents by a system, (b) an error in operation of the system that is not supposed as the error in work and (c) an error in work that is not judged as an error by the system but is judged by person, although in the embodiment the error is not specified.

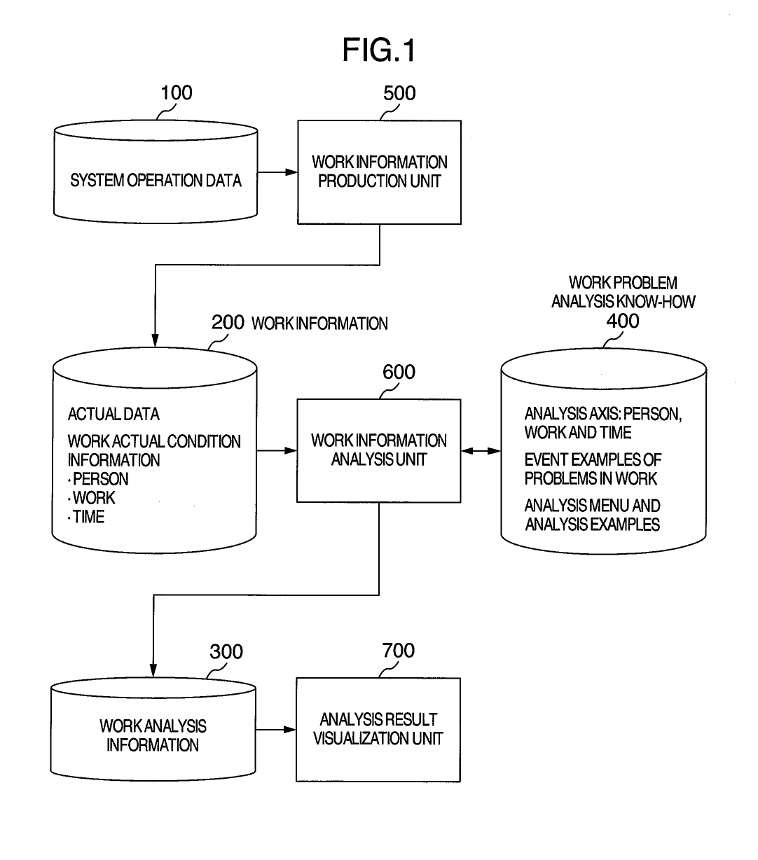

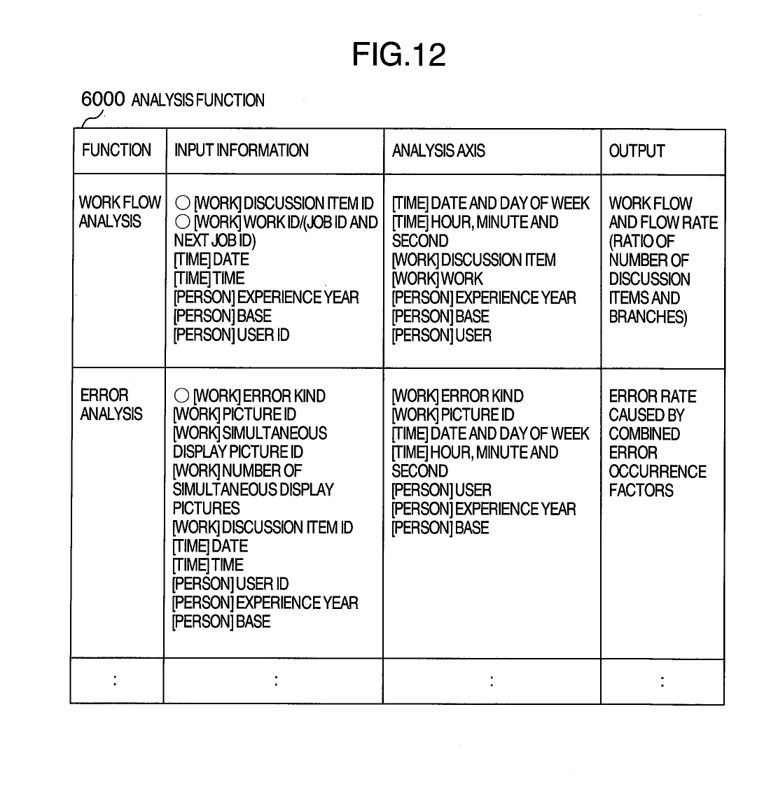

FIG. 1 is a schematic diagram of a system according to the embodiment. A system operation data memory 100 stores therein system log generated when a worker utilizes a work system and, for example, stores information such as a request from a user terminal to an application server and a response of the server to the request. Such system log is usually generated by a server and accordingly the system log generated during the period that is desired to be analyzed is stored in the system operation data memory 100. In the embodiment, the system log is supposed as system operation data, although information required for analysis may be taken out from packet information between the server and the client. Work information stored in work information memory 200 is information group used for analysis of work information. Information stored in the system operation data memory 100 is shaped by a work information production unit 500 to produce necessary information and store it in the work information memory 200. A work problem analysis know-how memory 400 stores therein “analysis menu and analysis examples”, “event examples of problems in work” in which event examples of problems in work obtained from investigation in the field such as observation or interview corresponds to events understood from data analysis, and “analysis axis” for making analysis, and an analyzer makes analysis with reference to analysis examples and event examples of problem candidates. A work analysis information memory 300 stores therein analysis results of data read from the work information memory 200 and analyzed by means of analysis function 6000 shown in FIG. 12. An analysis result visualization unit 700 displays the analysis results stored in the work analysis information memory 300 in the format designated by the user such as a format in which the analysis results are superposed on a work flow and a table format.

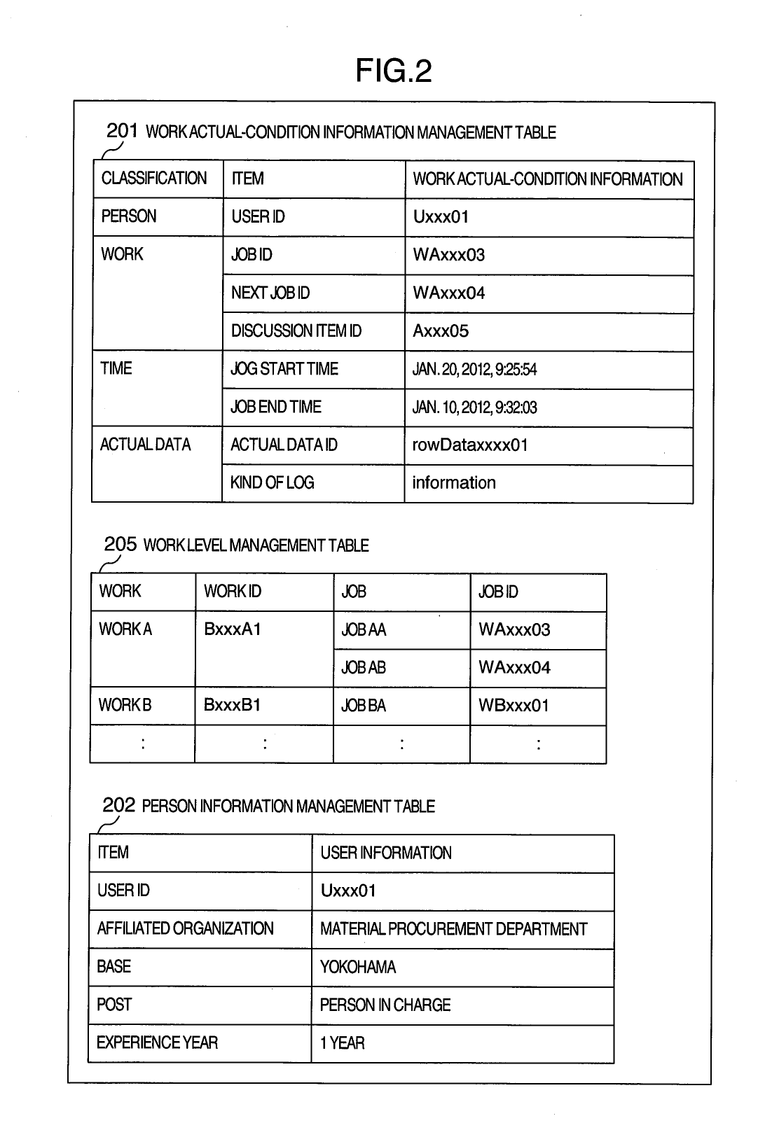

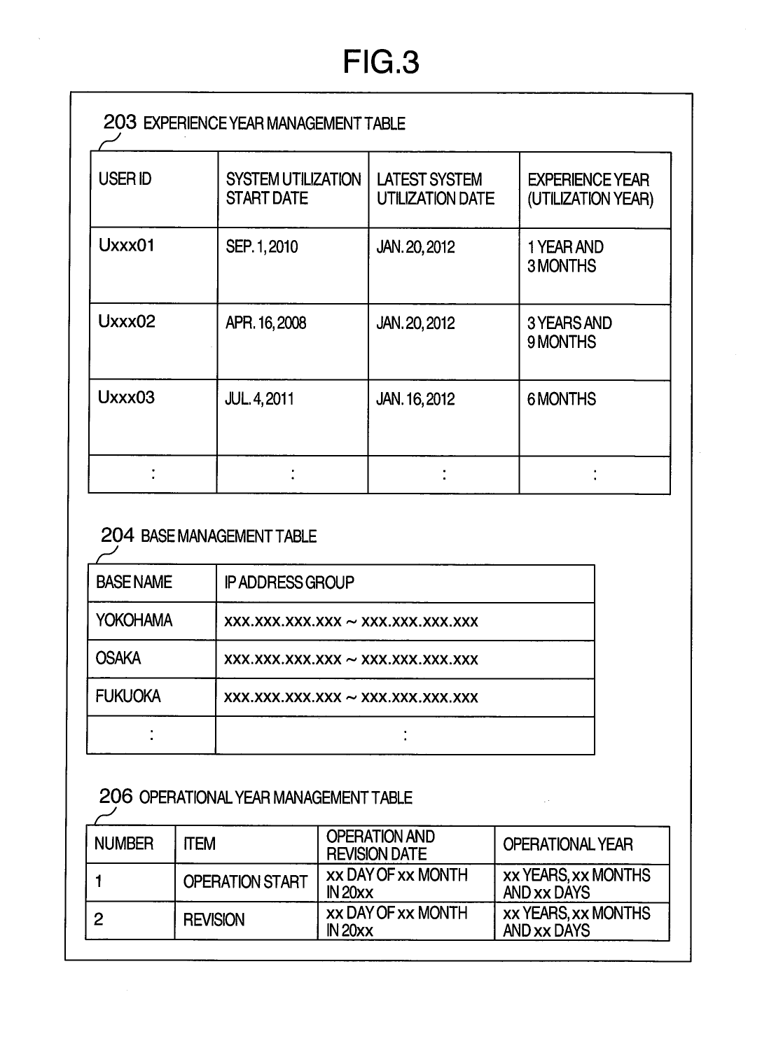

FIG. 2 shows the structure of a work actual-condition information management table 201, a user management table 202 and a work level management table 205 stored in the work information memory 200. The work actual-condition information management table 201 is classified into person, work and time. User ID in the work actual-condition information management table 201 is ID assigned to each of the system users and is the same as user ID stored in the user management table 202. Job ID is given in order to define jobs constituting work at the design stage, although it is not often defined. When the job ID is not outputted, picture ID or URL on Web picture may be used as the job ID. When job start/end time is not outputted, request/response time on picture is used as job start time and job end time is made to be the same as start time of next job. When picture showing division of job is displayed and information representing that a button for movement from the picture is clicked is obtained, the time that the clicking is made is set to be the job end time. When discussion item ID is not outputted, a column corresponding thereto is blanked. It is difficult to get an affiliated organization and a post or official position in the user management table 202 from the system operation data and accordingly when the affiliated organization and the post are managed in another system, information thereof is obtained from the other system to be utilized or the information is inputted by hand or when data is not obtained, columns therefor are blanked. Base information may utilize information of another system similarly or may be inputted by hand, although the fact that IP address is assigned in accordance with an installation place of a terminal may be utilized to manage the IP address and the base in a corresponding manner as shown in a base management table 204 of FIG. 3 and the base information may be obtained from the IP address information of terminal contained in system operation data and be recorded in the user management table 202 in a corresponding manner to the user ID. Similarly to the base information, experience years in the user management table 202 are linked with experience years in an experience year management table 203. A work level management table 205 is a table in which levels of jobs constituting work are managed. The work level management table is sometimes prepared as a work function level diagram at the design stage, although when there is no material, information thereabout is obtained from interview with worker in the field or working manual to prepare the table or is presumed from work flow to prepare the table. Further, the process mining technique may be used to analyze the relation among jobs and grouped jobs may be positioned as work to thereby produce the table automatically.

FIG. 3 shows the structure of the experience year management table 203 and the base management table 204 stored in the work information memory 200. The experience year management table 203 manages user ID, system utilization start date, latest system utilization date and utilization years of the user. The experience year management table 203 is a table for making analysis based on experience years of work by replacing utilization years of system with experience years of work and when the experience years of a certain user ID is updated, the experience years of the user management table 202 shown in FIG. 2 is also updated. The base management table 204 is a table in which IP addresses are managed in a corresponding manner to the bases. When this correspondence table is managed in a different system, information managed in the different system is utilized or is inputted by hand or when data is not obtained, the table are blanked. Operational year management table 206 is a table for managing operational years of system and is used when change by system operational years or variation of data just after the system is revised is analyzed. Time series analysis for every month and each day of the week is made using calendar information and operation start/end time.

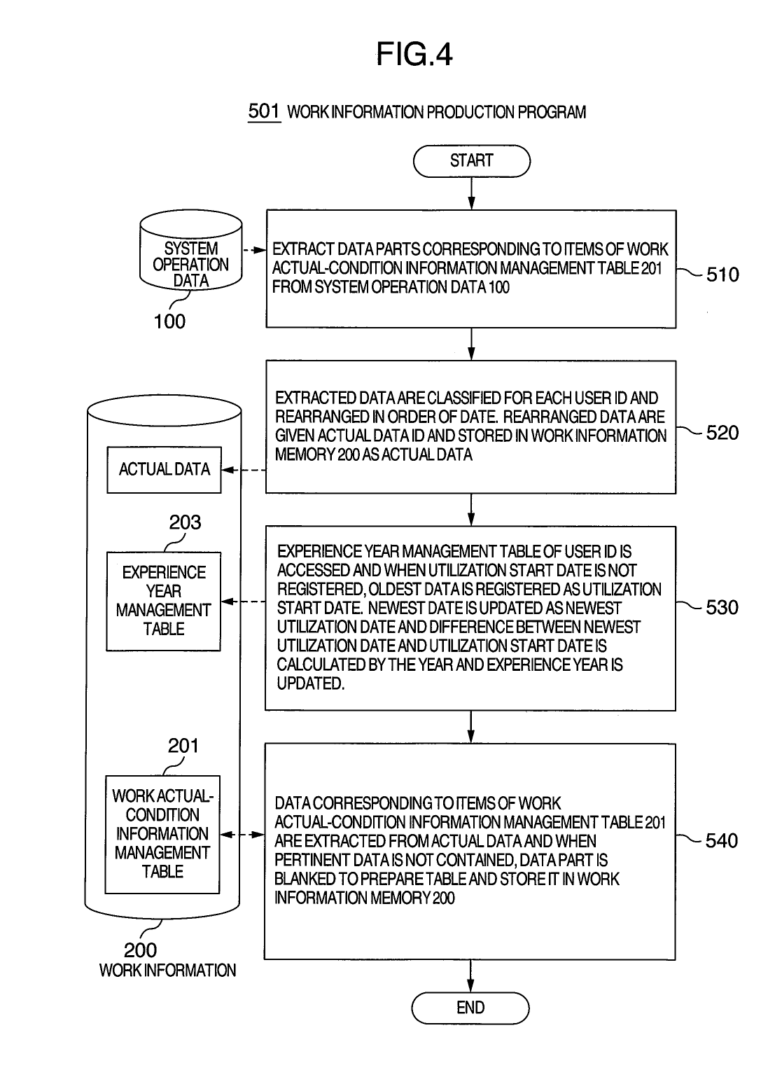

FIG. 4 is a flow chart showing the processing performed by a work information production program 501 running in the work information production unit 500. When the program is started, data parts corresponding to the items of the work actual-condition information management table 201 are extracted from the system operation data 100 in step 510. In step 520, the extracted data are classified for each user ID and are rearranged in order of date. Further, the rearranged data are given actual data ID to be stored in the work information memory 200 as actual data.

Next, the processing proceeds to step 530, in which experience year data is prepared/updated for each user ID. First, the experience year management table 203 is accessed to confirm whether utilization start date of user ID for preparation/update is registered or not. When the utilization start date is not registered, date at oldest operation start time among data of the user ID is registered as the utilization start date. Next, date at newest or latest operation start time is updated as newest utilization date. Finally, difference between the newest utilization date and the utilization start date is calculated by the year and experience years are updated. The experience years of all users for the date extracted in step 510 are confirmed and the processing proceeds to next step 540. In step 540, data corresponding to the items of the work actual-condition information management table 201 are extracted from actual data. When the data corresponding to the item is not contained in the actual data, the data part is blanked to prepare the table and store the table in the work information memory 200. Even if there is no data corresponding to the data item, picture is interpreted as operation and data may be prepared.

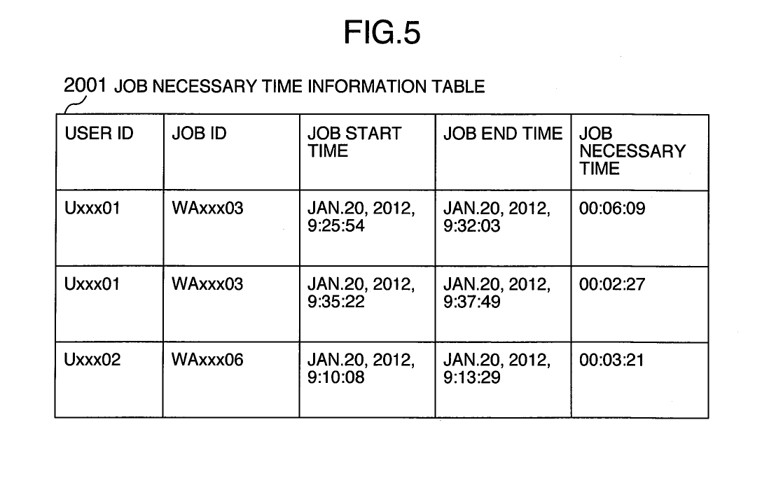

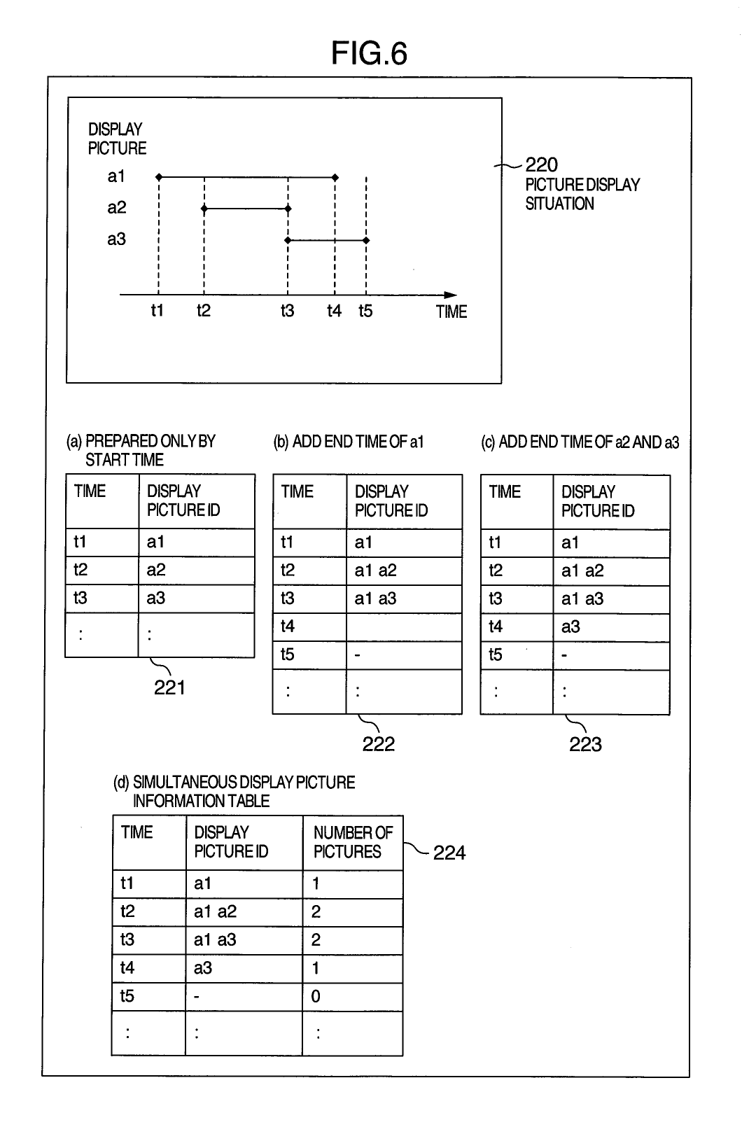

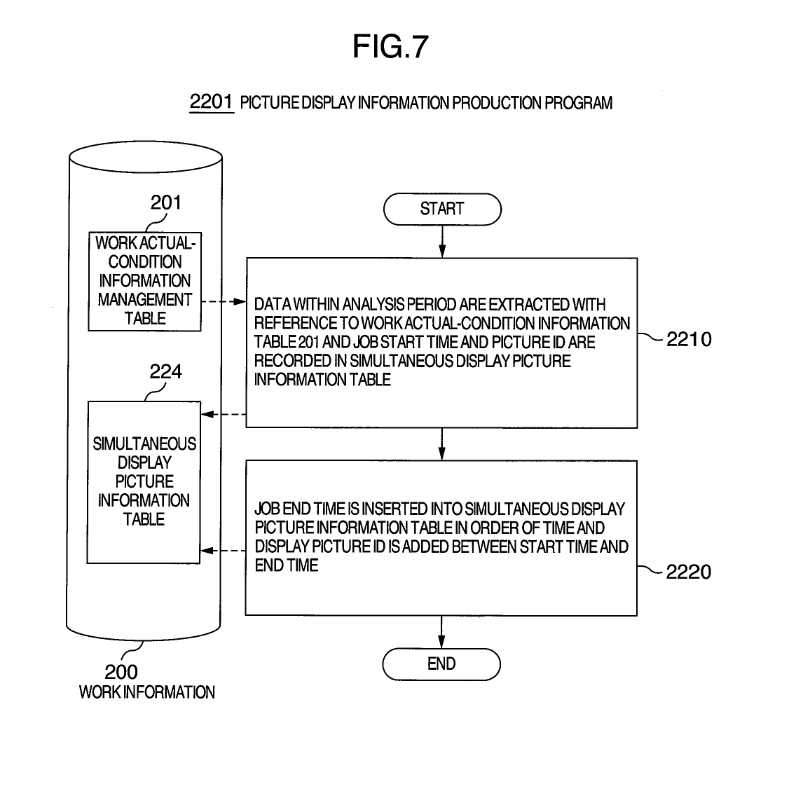

FIG. 5 shows the structure of a job necessary time information table 2001. The job necessary time information table 2001 manages job start time, job end time and job necessary time calculated by difference between the job end time and the job start time for each of users, discussion items and jobs. FIG. 6 shows the procedure of preparing data for analyzing the situation that each individual user uses plural pictures to perform job and the structure of simultaneous display picture information tables prepared by this procedure. The term of “simultaneous” display picture is used, although displays and use are necessarily not required to be simultaneous. The procedure of producing simultaneous display picture information by a picture display information production program 2201 of FIG. 7 is described by taking the case where a certain user displays picture of a1 from time t3 to t5, displays picture of a2 from time t2 to t3 and displays picture of a3 from time t3 to t5 as shown by picture display situation 220 as an example. First, in step 2210, data within analysis period are extracted from the work actual-condition information management table 201 and picture ID's displayed at that time are registered in the simultaneous display picture table 224 as provisional information. The provisional simultaneous display picture table 224 at this time is set as table 221. Next, in step 2220, job end time is inserted into the provisional simultaneous display picture table 221 in order of time and display picture ID is added in part later than start time and earlier than end time. For example, since end time of picture a1 is t4, t4 is inserted behind t3 and display picture ID a1 is added in t2 and t3 existing between t1 and t4. Pictures a2 and a3 are also subjected to the same processing, so that simultaneous display picture information table 224 is prepared.

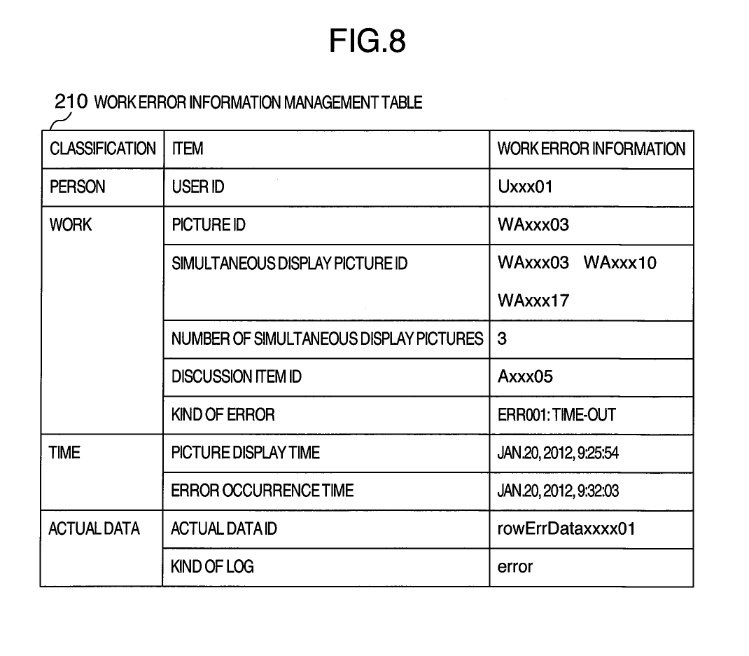

FIG. 8 shows the structure of a work error information management table 210. The work error information management table 210 has the substantially same structure as the work actual-condition information management table 201 and includes information relative to error extracted from the system operation data 100. The work error information management table 210 stores therein picture ID displayed when error occurs, simultaneous display picture ID's, the number of simultaneous display pictures and occurrence time of error.

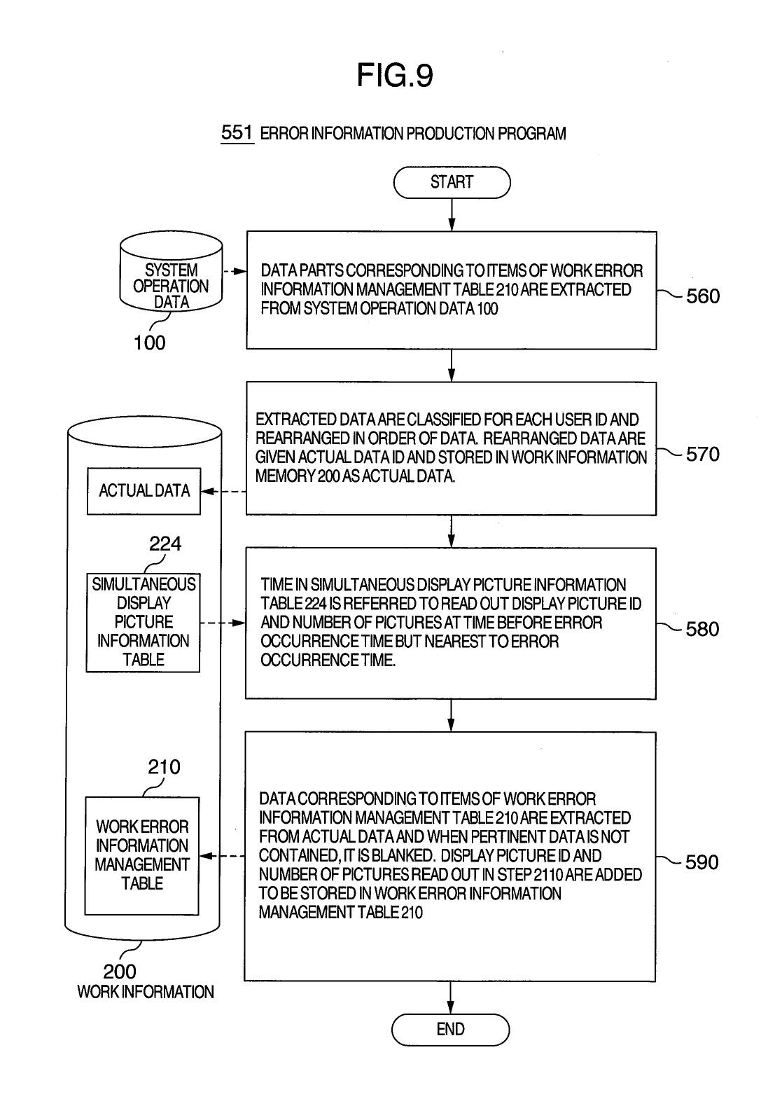

FIG. 9 is a flow chart showing the processing performed by an error information production program 551 for producing the work error information management table 210. When the program is started, data parts corresponding to items of the work error information management table 210 are extracted from the system operation data 100 in step 560. In step 570, the extracted data are classified for each user ID and are rearranged in order of date. The rearranged data are given actual data ID to be stored in the work information memory 200 as actual data. Next, in step 580, time in the simultaneous display picture information table 224 is referred to read out display picture ID and the number of pictures at time before the error occurrence time but nearest to the error occurrence time. In step 590, data corresponding to items of the work error information management table 210 are extracted from actual data and when pertinent data is not contained, the item corresponding to the data is blanked. Further, the display picture ID and the number of pictures read out in step 2110 are added to be stored in the work error information management table 210.

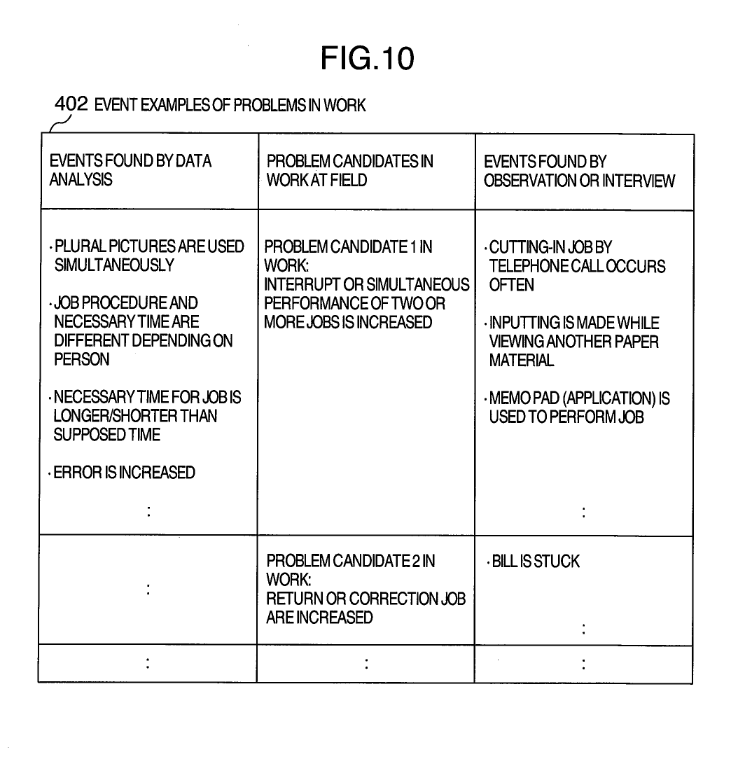

FIG. 10 shows event examples 402 of problems in work stored in the work problem analysis know-how memory 400. When the event that “plural pictures are used simultaneously” is found by data analysis, for example, the event can be grasped as being the event of work problem candidate that “interrupt or simultaneous implementation of two or more jobs is increased”. Further, the problem can be grasped as containing the possibility that event found by observation that “interrupt job in the field by telephone call often occurs” or “inputting is made while viewing another paper material” occurs. An event sometimes occurs actually in which interrupt by telephone call occurs while certain job is performed and another picture is displayed to perform job about discussion item using telephone while original picture is left to be opened and thereafter the picture is returned to the original picture. Since the event found by data analysis and the event found by observation or interview are not related in one-to-one correspondence manner, it is necessary to judge plural events collectively to find problem candidates actually, although it is understood that there is a possibility that problem candidates appear as event of a certain kind and accordingly it can be very helpful in data analysis. When data analysis and user analysis using observation or interview are performed to find new problem candidates and event examples, the event examples 402 of problems in work are spread.

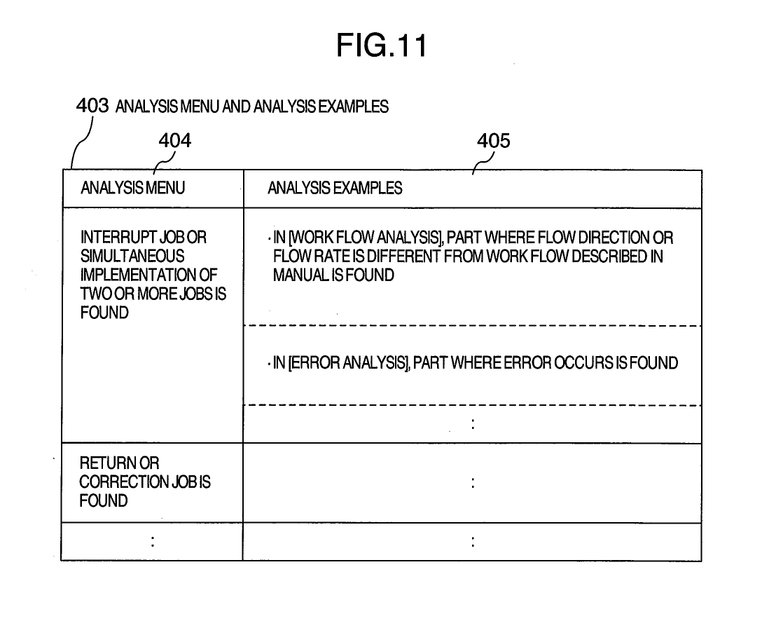

FIG. 11 shows an example of analysis menu and analysis examples 403 stored in the work problem analysis know-how memory 400. In order to find problem candidates in work at the field by using the analysis menu 404, the analysis menu corresponds to problem candidates in work at the field of the event examples 402 of problems in work shown in FIG. 10. The analysis examples 405 show viewpoints and analysis methods of suggesting how analysis is made in order to find problem candidates. For example, in the analysis menu that “interrupt job or simultaneous implementation of two or more jobs is found”, there are described analysis examples that “in (work flow analysis), part where flow direction or flow rate is different from work flow described in manual is found” and “in “(error analysis), part where error occurs is found”. The analysis example corresponding to the analysis menu selected by the analyzer can be shown to support data analysis by analyzer having no experience. When new problem candidate and analysis example are found on the way of analysis, the analysis menu 404 and analysis example 405 are spread.

FIG. 12 shows an example of data analysis function performed by work information analysis unit 600. It is not necessary to provide all of input information shown in FIG. 12, although input information having ◯ mark attached at head is necessary. For example, in work flow analysis function, data group including “date”, “time”, “discussion item ID” and “work ID or job ID and next job ID” in a set is inputted as outline data and order of works or jobs for each discussion item is flow, so that the number of works flowing as discussion item is outputted as the flow rate. The reason that work ID or job ID is used is that one work or job is composed of plural steps and detail degree of work and job is changed depending on to what extent each step is described in detail. The standard of job level and its description method is stipulated and the detail degree can be made uniform in accordance with the standard, although in the embodiment the detail degree is not stipulated and only level indicating that work is composed of plural jobs is stipulated. In the general Web system, since a picture request from terminal to server (HTTP request log) or response information from server (information log of application server and the like) is often inputted to the system operation data 100, picture may be interpreted as job and analyzed. In this case, the transition route of picture and the number of displays of pictures are outputted to be analyzed as job flow and flow rate. When “next job ID” can be obtained, it is understood that job flows from “job ID” to “next job ID”, although when “next job ID” cannot be obtained, jobs having the same “discussion item ID” are arranged in order of time to thereby analyze the job flow. When picture to be referred is understood as HTTP request, picture (URL) to be referred is used as “job ID” and requested picture (URL) is used as “next picture ID” to analyze the job flow.

Analysis is not ended only once and the analysis axis is used to make drilling-down. The drilling-down is an analysis method that a target is narrowed down from outline data to detailed data when data in multidimensional database are analyzed. In the case of work flow analysis, “date”, “time”, “discussion item ID” and “work ID or job ID and next job ID” are used as outline data to visualize an overall picture of work or job flow and flow rate and when part that weighs on mind is contained in the flow and the flow rate, the part is subjected to drilling-out to make detailed analysis. For example, when a flow that is not contained in the job flow at the design stage is displayed and the flow is desired to be analyzed in detail, the flow and the flow rate can be understood for each of “date and day of week”, “hour, minute and second” and “discussion item” when input data used in outline analysis is used, although additionally the flow and the flow rate for each of “experience year”, “base” and “user” can be understood. The reason that such input information and analysis axis are added to the detailed analysis is that there is tendency that analysis is liable to be influenced due to difference in work experience such as occurrence of difference in work efficiency and quality due to experience years and job rules different depending on bases.

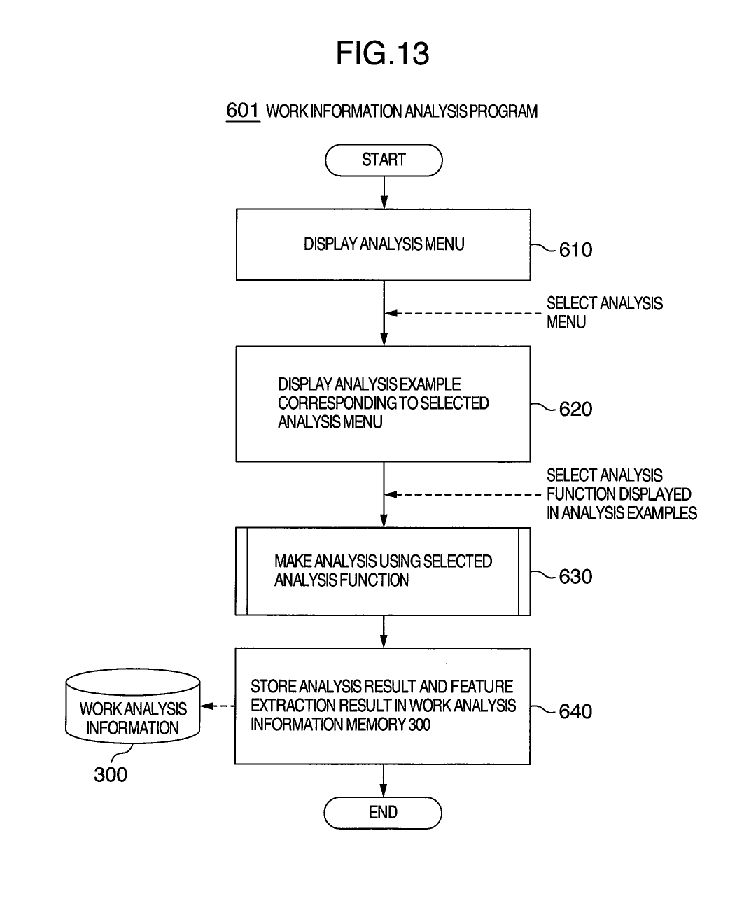

FIG. 13 is a flow chart showing the processing performed by a work information analysis program 601 running in the work information analysis unit 600. In step 610, the analysis menu 404 shown in FIG. 6 is displayed as a picture. A picture example in case where the user selects the analysis menu by pull-down method is shown as picture example 810 for selecting analysis function from the analysis menu and analysis example of FIG. 11. When the user selects the analysis menu, the analysis example 405 corresponding to the menu is displayed in step 620. For example, in the picture example 810 for selecting the analysis function from the analysis menu and the analysis examples of FIG. 11, the user selects the analysis menu that “interrupt job or simultaneous implementation of two or more jobs is found” and then selects the analysis menu that “work or job delayed in (necessary time analysis) is found”. Here, in order to make the necessary time analysis, the necessary time analysis is started in step 630 and its result is stored in the work analysis information memory 300 in step 640.

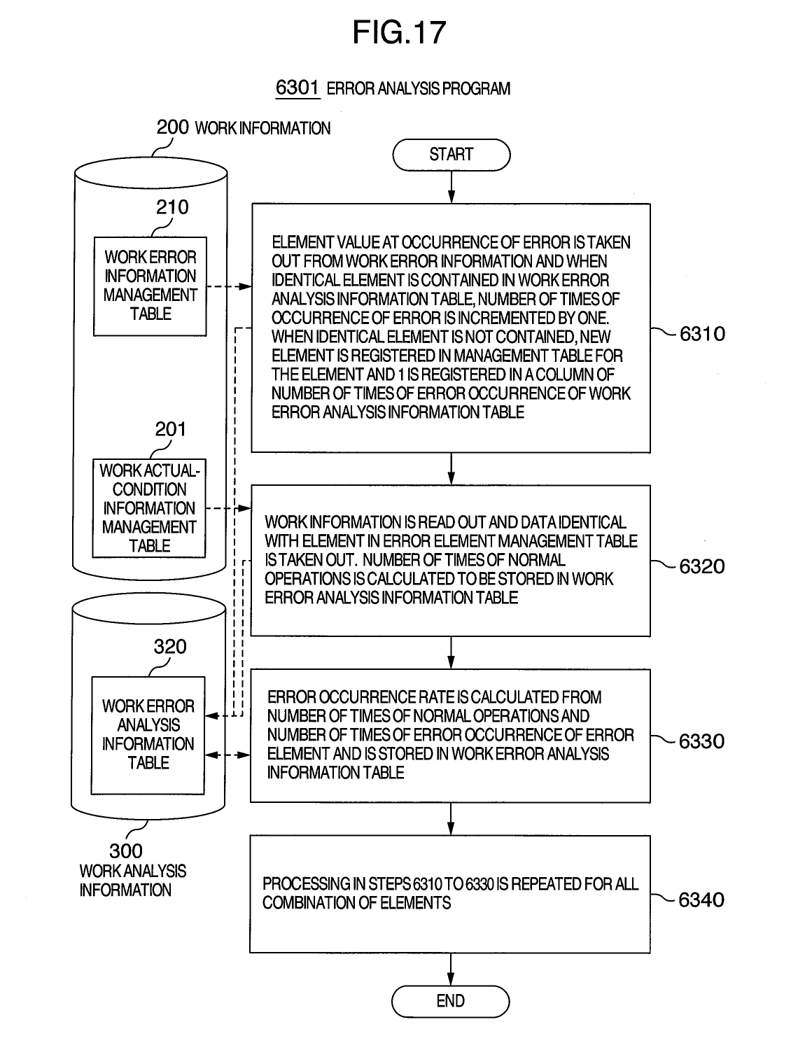

With regard to the analysis program started in step 630, since various methods for making data analysis are disclosed and it is premised that these analysis programs are utilized, detailed description thereof is omitted. An error analysis program 6301 of FIG. 17 is shown as an example of the analysis program.

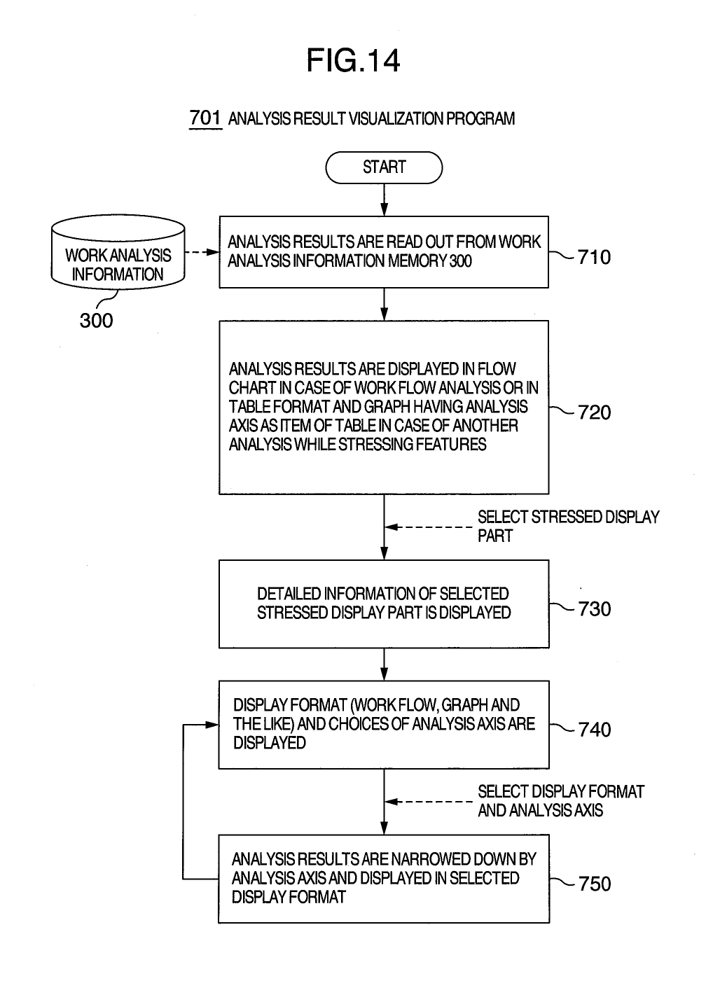

FIG. 14 is a flow chart showing the processing performed by an analysis result visualization program 701 running in the analysis result visualization unit 700. In step 710, analysis results are read out from the work analysis information memory 300 and in step 720 the analysis results are displayed in a flow chart in case of work flow analysis and in a table format having the analysis axis as an item of the table in case of another analysis. Then, processing proceeds to step 730. In step 730, data for another visualizable expression such as graph format is prepared. Then, in step 740, the visualizable display format prepared in step 730 and choices of the analysis axis are displayed. When the user selects the display format and the analysis axis, the analysis results are narrowed down by the selected analysis axis and are displayed in the selected display format. Thereafter, the processing in steps 740 and 750 is repeated and the results analyzed by the selected display format and analysis axis are displayed repeatedly each time the user selects the display format and the analysis axis.

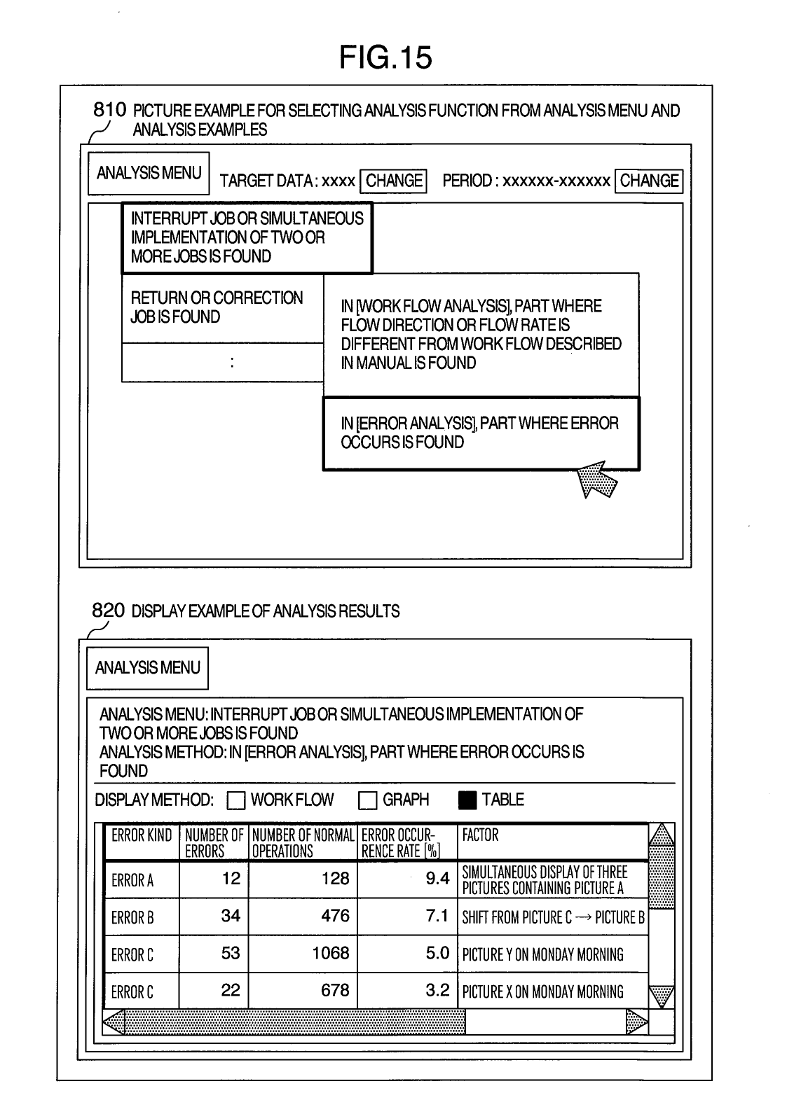

FIG. 15 is a diagram showing an analysis picture example. The outline of analysis procedure is described with reference to FIG. 15. It is supposed that work information is produced from the system operation data memory 100 and is stored in the work information memory 200. The analyzer selects the analysis menu and makes detailed analysis while viewing displayed results. First, when the analyzer selects “interrupt job or simultaneous implementation of two or more jobs is found” from the analysis menu as shown in the picture example 810 for selecting the analysis function from the analysis menu and analysis example shown in FIG. 15, the analysis examples necessary for the analysis menu are displayed. When “part where error occurs is found in (error analysis)” is selected from the analysis examples, the analysis function is started to make error analysis 6301 and its analysis result is displayed as shown in a display example 820 of analysis result. In the display example 820 of analysis result, a picture A is displayed and 128 cases where three pictures containing the picture A and other display pictures together are displayed at the same time occur and 12 cases thereamong display that an error of kind named error A occurs. The number of cases where error occurs can be displayed together with an occurrence rate, so that it can be judged whether error occurs in work that is utilized often or rarely.

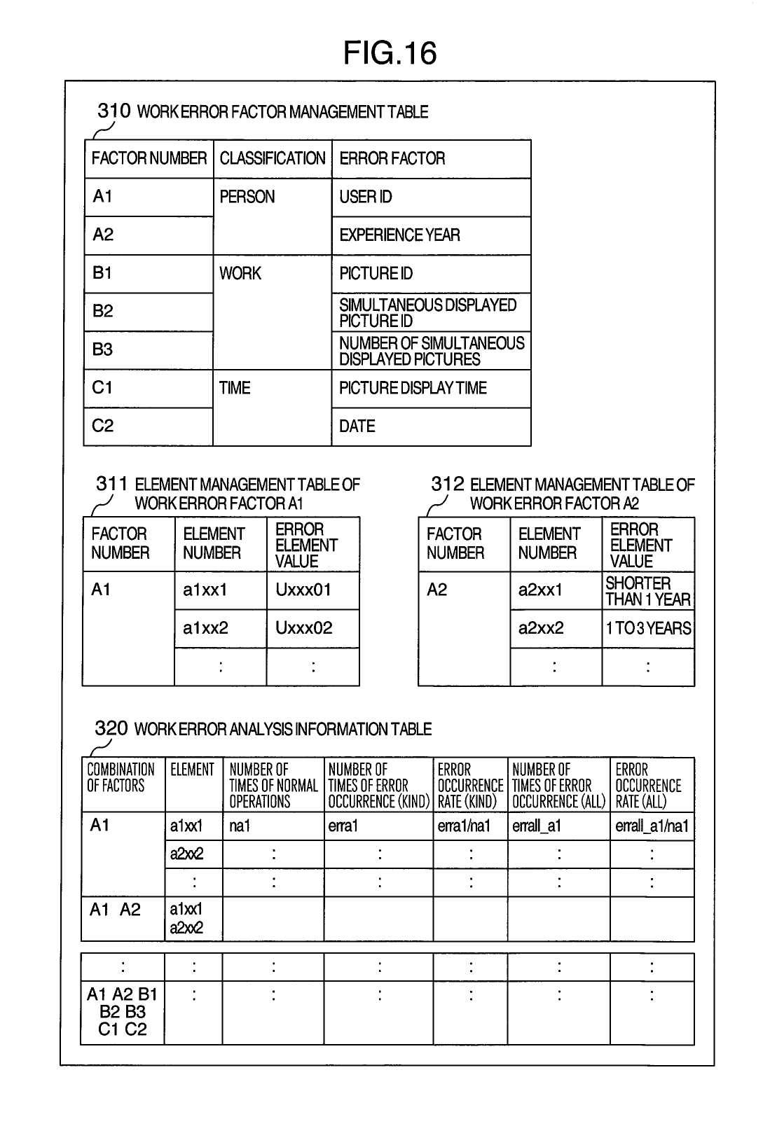

FIG. 16 is a diagram explaining a way of considering error analysis. There are various factors that cause error. The factors are independent in a case and probability is enhanced by interrelation among factors in a case. Whether the factors are interrelated can be analyzed by the method that the probability for occurrence of error is calculated about many kinds of combination of factors that the analyzer considers, although it takes time and labor to calculate all kinds of combination of factors by the analyzer and it is not realistic. However, since the interrelation sometimes occurs in part where the analyzer does not consider, the error occurrence probability caused by combination of factors is calculated by a computer and the calculated result can be used to support the analysis. The present invention is to show, as the factor of error analysis, the error occurrence rate relative to the person's job situation in which error is liable to occur in case where another job breaks into current job when a worker performs the job and then the worker returns to the original job. Analysis of the error factors to which attention is not paid in the conventional error analysis in that “plural jobs are performed?” and “what time does it take to perform the job containing the broken-in job?” is supported.

A work error factor management table 310 shows configuration examples of the error factors in case where person's job is noticed. The factors contain not only user ID and picture ID at the time that error occurs but also ID and the number of other pictures displayed in parallel at the time of occurrence of error, display time of a picture causing error and the like. In addition to these factors, user ID and picture ID at the time that error occurs actually are elements. An element management table 311 of work error factor A1 shows an example of element values of the factor A1 and an element management table 312 of work error factor A2 shows and example of element values of the factor A2. Similarly, there are element management tables for element numbers such as B1 and B2. When an error occurs, the number of times of occurrence of work having the same elements and the number of times of occurrence of error in work having the same elements are calculated and the number of errors occurred and the occurrence rate are calculated to display the calculation results. However, for the number of simultaneously displayed pictures, the number of times that the pictures are displayed in numbers exceeding error element values is calculated. The analyzer can judge what combination of elements is important with reference to the occurrence rate and presume the error factors.

FIG. 17 is a flow chart showing the processing performed by an error analysis program 6301. When the program is started, work error information is read out from the work error information management table 210 to take out element values at occurrence of error in step 6310 and when an identical element is contained in work error analysis information table 320, the number of times of occurrence of error for the element is incremented by one. When the identical element is not contained, the new element is registered in management table for the element and 1 is registered in a column of the number of times of error occurrence of the work error analysis information table 320. Next, in step 6320, work information such as the work actual-condition management information 201 is read out and data identical with the error element taken out in step 6310 is taken out. Then, the number of times of normal operations is calculated to be stored in the work error analysis information table 320. Next, in step 6330, the error occurrence rate is calculated from the number of times of normal operations and the number of times of error occurrence of the error element and is stored in the work error analysis information table 320. The processing in steps 6310 to 6330 is repeated for all combination of elements and the processing is ended. As described above, the number of times of error occurrence and the number of times of normal operations are calculated for all combination of elements for the factors set as the error factors and the error occurrence rate is calculated.

For example, when the analysis result that the error occurrence rate is high is obtained in case where plural pictures are displayed, there is considered the possibility that the current processing is replaced by processing of another discussion item since the worker performs plural jobs simultaneously or the worker forgets contents stored before when the job is returned from another job, so that the worker must perform job again and it takes time to complete the job. It cannot be decided whether the event that the error occurrence rate is increased when plural pictures are displayed occurs from the problem that interrupt or simultaneous implementation of two or more jobs is increased, although the reliability of error analysis can be improved by combination of other data analysis such as change of the number of discussion items in time series and simultaneous utilization of plural pictures.

Further, when the event example 402 of problem in work is referred to, it is understood that there is a possibility that there occurs the event such as frequent occurrence of interrupt by telephone call and inputting while viewing another paper material. For example, there is also considered a possibility that when there is a telephone call from another customer while contents received from another telephone are data inputted in reception work of a contact center and the data inputting operation is interrupted to attend to the customer by telephone, the contents heard from the customer are memorized and data input operation is made together later. Such possibility cannot be confirmed unless the field is observed or interview is made to the person in charge but can be utilized as material of interview to system user and auxiliary material in investigation by specialist.

As described above, the analyzer starts analysis from the analysis menu and repeats the procedure that analysis targets are narrowed down if necessary and the events shown from data are confirmed. Since the problems in work and the events are not related in one-to-one correspondence manner, it is necessary that the analyzer judges plural events collectively to find the problem in work. Since the analysis menu 404 and the event examples 402 of the problem in work are related in a corresponding manner, the event examples 402 of the problem in work can be used as reference information that what event can be understood by using the analysis menu 404 and to what problem the event understood is related as analysis result using the analysis menu 404.

According to the embodiment, candidates of latent problems in work in the system user can be found from the system operation data and exact system improvement proposal activity in system user's viewpoint can be made. Further, before the user analysis using the ethnography is made, the method of the embodiment can be utilized to investigate the field, so that where and when investigation is made can be understood and accordingly effective investigation activity can be made.

It should be further understood by those skilled in the art that although the foregoing description has been made on embodiments of the invention, the invention is not limited thereto and various changes and modifications may be made without departing from the spirit of the invention and the scope of the appended claims.

1. A work problem analysis support system comprising:
means to collect plural pieces of information representative of execution situation of work in execution of the work;
means to store each of the plural pieces of collected information in corresponding manner to attribute of the information;
means to specify information and attribute causing problem in execution of the work from the information; and
means to specify another attribute having relevance to the specified attribute to be related to the specified attribute and specify factor candidates of the problem.

2. A work problem analysis support system according to claim 1, further comprising:
means to display the factor candidates, and
wherein
the display means can display each of the factor candidates selectively.

3. A work problem analysis support system according to claim 2, wherein
the plural pieces of information contain person who performs the work, execution time and the work, and
the attribute contains experience year and work place of the person, date and day of week for the time, picture utilized in the work and job necessary time.

4. A work problem analysis support method comprising:
a step of collecting plural pieces of information representative of execution situation of work in execution of the work;
a step of storing each of the plural pieces of collected information in corresponding manner to attribute of the information;
a step of specifying information and attribute causing problem in execution of the work from the information; and
a step of specifying another attribute having relevance to the specified attribute to be related to the specified attribute and specifying factor candidates of the problem.

5. A work problem analysis support method according to claim 4, further comprising:
a step of displaying the factor candidates, and
wherein
the display step can display each of the factor candidates selectively.

6. A work problem analysis support method according to claim 5, wherein
the plural pieces of information contain person who performs the work, execution time and the work, and
the attribute contains experience year and work place of the person, date and day of week for the time, picture utilized in the work and job necessary time.
